(19) United States
(12) Patent Application Publication
(10) Pub. No.: US 2026/0295840 A1
(43) Pub. Date: Oct. 1, 2026

(54) METHOD FOR CONTROLLING A ROBOTIC DEVICE FOR INSERTING A FIRST OBJECT INTO A SECOND OBJECT

(71) Applicant: Robert Bosch GmbH, Stuttgart (DE)

(72) Inventors: Hanna Ziesche, Leonberg (DE); Era Choshen, Giv'atayim (IL); Zohar Feldman, Haifa (IL)

(21) Appl. No.: 19/574,626

(22) Filed: Mar. 23, 2026

(30) Foreign Application Priority Data
Apr. 1, 2025 (EA) 25 16 7703.5

(51) Int. Cl. B25J 9/16

(52) U.S. Cl. CPC B25J 9/1679; B25J 9/161; B25J 9/1664; B25J 9/1697

(57) ABSTRACT

A method for controlling a robot device to insert a first object into a second object. The method includes: picking up the first object using a gripping tool of the robot device; moving the first object into the vicinity of the second object; capturing an image; ascertaining, using the and/or another image, a first transformation, which is a transformation between a coordinate system of the first object and a coordinate system of the gripping tool; ascertaining a second transformation by inputting the image as an input and the first transformation as a condition into a conditional neural network, wherein the second transformation specifies a transformation between the coordinate system of the gripping tool and a coordinate system of the second object; ascertaining, using the second transformation, a robot trajectory for inserting the first object into the second object; and controlling the robot device.

### BACKGROUND INFORMATION

Inserting one object into another object by means of a robot arm is an important problem in robotics, for example in the automated manufacturing of components, in household robots, etc. An illustrative example is inserting a plug into a socket. In this case it is necessary for a robot to be able to detect the plug, to be able to pick it up (e.g., grip it), and then to be able to move the picked-up plug toward the socket and insert it precisely thereinto. In this regard, O. Spector and D. Di Castro: “InsertionNet—A Scalable Solution for Insertion”, arXiv:2104.1422, 2021 (hereinafter referred to as Reference [1]) describes a two-stage approach in which the picked-up plug is first moved into the vicinity of the socket and then, using images, a difference between a coordinate system of the plug and a coordinate system of the socket is ascertained in order to insert the plug into the socket according to the difference.

### SUMMARY

The model described in Reference [1] is trained on a specific use case (e.g., inserting a particular plug into a particular socket) and assumes a canonical grip configuration of the plug. It has been found that if the plug is gripped in a manner that deviates even only slightly from the canonical grip configuration, the performance of the model decreases greatly, and if the model is transferred to different but similar use cases (e.g., if it involves another (even only slightly deviating) type of plug), the performance of the model decreases significantly.

The present disclosure relates to a method for controlling a robot device to insert a first object into a second object. This method has high performance even in the case of the changes described above. In clear terms, a more robust method for inserting one object into another is provided. This is achieved, for example, by using a conditional neural network, which uses information about how the object is gripped by the gripping tool as a condition.

Different aspects relate to a method for controlling a robot device to insert a first object into a second object. According to an example embodiment, the method comprises: controlling the robot device to pick up the first object (according to a pick-up robot configuration) by means of a gripping tool of the robot device; moving the first object into the vicinity of the second object (according to an initial robot trajectory); capturing at least one image showing the second object and the first object (picked up by means of the gripping tool and) located in the vicinity of the second object; ascertaining, using the at least one image and/or at least one other image showing the first object and the gripping tool, a first transformation, which is a transformation between a coordinate system of the first object and a coordinate system of the gripping tool; ascertaining a second transformation by inputting the at least one image as an input and the first transformation as a condition into a conditional neural network, wherein the second transformation specifies a transformation between the coordinate system of the gripping tool and a coordinate system of the second object; ascertaining, using the second transformation, a robot trajectory for inserting the first object into the second object; and controlling the robot device according to the robot trajectory.

Various exemplary embodiments are specified below.

Example 1 is the method for controlling the robot device to insert the first object into the second object as described above.

Example 2 is configured according to Example 1, wherein ascertaining the first transformation using the at least one image and/or the at least one other image comprises: inputting the at least one image and/or the at least one other image into a machine learning model that is configured to output the first transformation in response to the input of the at least one image.

In clear terms, the machine learning model can be trained to output, using one (or more than one) image showing an object gripped by the gripping tool, a transformation between the coordinate system of the object and the coordinate system of the gripping tool.

In Example 3, the method according to Example 1 or 2 can optionally further comprise: during the movement of the first object into the vicinity of the second object according to an initial robot trajectory: (continuously) capturing (e.g., measuring) a current force and a current torque (e.g., by means of at least one force-torque sensor) with which the gripping tool has picked up (e.g., is holding, gripping, etc.) the first object; and ascertaining whether the current force is greater than or equal to a force threshold value and whether the current torque is greater than or equal to a torque threshold value; wherein the (adjusted) robot trajectory is ascertained by ascertaining the first transformation and the second transformation, and the robot device is controlled according to the robot trajectory if the current force is greater than or equal to the force threshold value and the current torque is greater than or equal to the torque threshold value.

In clear terms, the first object can be moved according to an initially ascertained robot trajectory in order to be inserted into the second object. The force and the torque above the respective threshold values can specify that a collision (e.g., of the first object and/or the gripping tool with the second object) has occurred. If this is the case, a new, adapted robot trajectory can then be ascertained according to the method described herein (e.g., in Example 1) in order to insert the first object into the second object without collision. In clear terms, the method described herein can be used as a correction, as it can ascertain the robot trajectory with higher accuracy than the initial robot trajectory.

Example 4 is configured according to one of Examples 1 to 3, wherein the conditional neural network has a plurality of layers, each layer of which is configured to apply as a function of the input condition (i.e., the first transformation) a corresponding affine transformation to each feature ascertained in the layer.

It has been shown that such a conditional neural network has a particularly high success rate (and thus accuracy of the ascertained robot trajectory) when controlling robot arms.

Example 5 is configured according to one of Examples 1 to 4, wherein the second transformation is the transformation between the coordinate system of the gripping tool and the coordinate system of the second object; or wherein the second transformation is a transformation between the coordinate system of the first object and the coordinate system of the second object and specifies, using the first transformation, the transformation between the coordinate system of the gripping tool and the coordinate system of the second object.

In clear terms, the second transformation can either directly or indirectly specify the transformation between the coordinate system of the gripping tool and the coordinate system of the second object.

Example 6 is configured according to one of Examples 1 to 5, wherein controlling the robot device according to the robot trajectory comprises: controlling a robot arm of the robot device, which robot arm has the gripping tool (as an end effector), according to the robot trajectory.

Example 7 is a control device that is configured to carry out the method according to one of Examples 1 to 6.

Example 8 is a robot device having a robot arm with the gripping tool and having the control device according to Example 7.

Example 9 is a computer program comprising commands that, when executed by a processor, cause the processor to perform the method according to one of Examples 1 to 6.

Example 10 is a computer-readable medium that stores commands that, when executed by a processor, cause the processor to perform the method according to one of Examples 1 to 6.

In the figures, similar reference signs generally refer to the same parts throughout the various views. The figures are not necessarily true to scale, with emphasis instead generally being placed on the representation of the principles of the present disclosure. In the following description, various aspects are described with reference to the figure.

### BRIEF DESCRIPTION OF THE DRAWINGS

FIG. 1 shows a robot device arrangement according to various aspects of the present disclosure.

FIG. 2 is a flowchart of a method for controlling a robot device to insert a first object into a second object according to various aspects of the present disclosure.

FIG. 3 is a schematic flowchart for ascertaining a robot trajectory for inserting the first object into the second object according to various aspects of the present disclosure.

### DETAILED DESCRIPTION OF EXAMPLE EMBODIMENTS

The following detailed description relates to the figures, which show, by way of explanation, specific details and aspects of this disclosure in which the subject matter can be carried out. Other aspects may be used, and structural, logical, and electrical changes may be performed without departing from the scope of protection of the present disclosure. The various aspects of this disclosure are not necessarily mutually exclusive, since some aspects of this disclosure may be combined with one or more other aspects of this disclosure to form new aspects.

Various examples are described in more detail below.

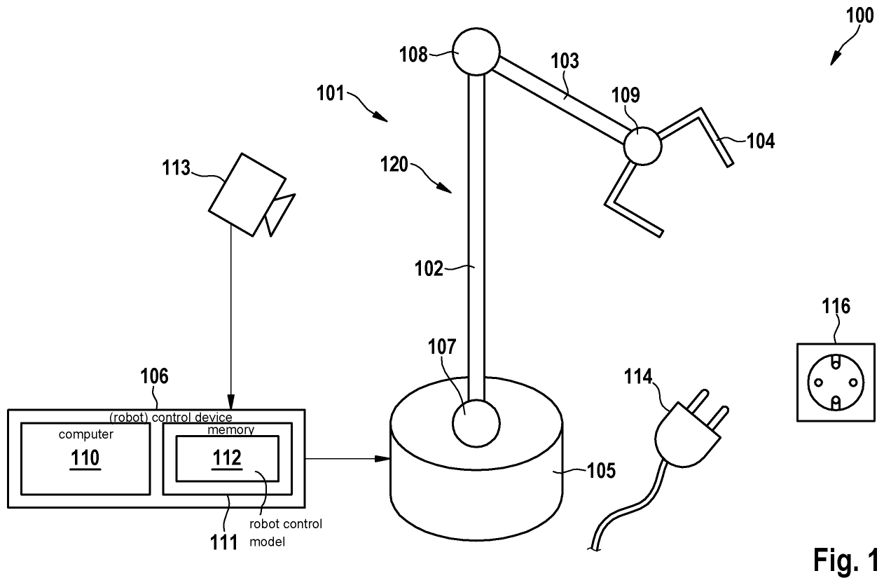

FIG. 1 shows a robot device arrangement 100 according to various aspects. The robot device arrangement 100 can have a robot device 101 (robot for short). The robot device 101 can have a robot arm 120 for picking up an object, moving the picked-up object, and inserting the object into another object.

The term “inserting” an object into another object, as described herein, can be understood as any type of robot-assisted insertion task in which one object is introduced into another object, such as interposing, inlaying, plugging in, etc.

For illustrative purposes, the insertion task is described herein in various aspects as inserting a plug 114 into a socket 116. It is understood that this serves for illustrative purposes and that the “inserting” described herein can be any kind of insertion of one object into another object, for example in the context of robot-assisted manufacturing, assembly, processing, etc., in the context of maintenance, in the context of a task performed by a household robot, in the context of a medical task performed by a medical robot, etc. In clear terms, the robot device 101 described herein can be any type of robot device that has a robot arm 120, such as a manufacturing robot, a maintenance robot, a household robot, a medical robot, etc.

The robot arm 120 can have robot links 102, 103, 104 and a base (or generally a mount) 105 by means of which the robot links 102, 103, 104 are supported. The term “robot links” can refer to the movable parts of the robot device 101, the actuation of which allows a physical interaction with the environment, for example in order to carry out the insertion task.

In order to control the robot device 101, the robot device arrangement 100 can have a (robot) control device 106, which is configured to implement the interaction with the environment according to a control program. The last element 104 (as seen from the base 105) of the robot links 102, 103, 104 is also referred to as an end effector 104. The type of the end effector 104 can establish whether the robot device 101 is capable of performing gripping and/or non-gripping object manipulations. A gripping object manipulation can refer to a manipulation of an object in which the object is gripped, whereas a non-gripping object manipulation can refer to a manipulation of an object in which the object is not gripped. Consequently, the robot device 101 can be capable of gripping object manipulation if the end effector 104 has at least one gripping tool (which can also be a suction device (e.g., a suction head) or the like). In any case, the robot device 101 can be capable of non-gripping object manipulation, for example by pushing the object (without gripping it), for example to change its lateral position and/or orientation.

The other robot links 102, 103 (closer to the base 105) can form a positioning device, so that, together with the end effector 104, a robot arm 120 (or articulated arm) is provided having the end effector 104 at its end. The robot arm 120 can be a mechanical arm that can provide similar functions to a human arm (possibly with a tool at its end).

The robot arm 120 can have connecting elements 107, 108, 109 which connect the robot links 102, 103, 104 to one another and to the base 105. A connecting element 107, 108, 109 can have one or more joints, each of which can provide a rotational movement and/or a translational movement (i.e., a displacement) for associated robot links relative to one another. The movement of the robot links 102, 103, 104 can be initiated by means of actuators which are controlled by the control device 106.

The term “actuator” can be understood to mean a component that is suitable for influencing a mechanism in response to being driven. The actuator can convert instructions output by the control device 106 (the so-called activation) into mechanical movements. The actuator, e.g., an electromechanical transducer, can be configured to convert electrical energy into mechanical energy in response to the triggering thereof.

The term “control device” (also referred to as “controller”) can be understood as any type of logical implementation unit that may include, for example, a circuit and/or a processor capable of executing software, firmware, or a combination thereof stored in a storage medium and that can issue the instructions, e.g., to an actuator in the present example. The control device can be configured, for example, by program code (e.g., software) to control the operation of a system, in the present example a robot.

In the present example, the control device 106 can have a computer 110 and a memory 111, which stores code and data on the basis of which the computer 110 controls the robot device 101.

According to various embodiments, the control device 106 can control the robot device 101 on the basis of a robot control model 112 stored in the memory 111.

As an example, the gripping task performed by the robot device 101 can be the insertion task, i.e., picking up (e.g., gripping or suctioning) the plug 114, moving the picked-up plug 114, and inserting the plug 114 into the socket 116. To carry out this task, the control device 106 can use images of the work region of the robot device 101, in which work region the plug 114 and the socket 116 are located.

These images of the environment of the robot device 101 can be supplied by one or more imaging sensors 113 (e.g., attached to the robot arm 120 or in some other way so that the control device 106 can control the viewing angle of the one or more imaging sensors 113).

An imaging sensor as used herein may be, for example, a camera (e.g., a standard camera, a digital camera, an infrared camera, a stereo camera, etc.), a radar sensor, a LIDAR sensor, an ultrasonic sensor, etc. Therefore, an image can be an RGB image, an RGB-D image, or a depth image (also called a D image). A depth image described herein may be any type of image that contains depth information. In clear terms, a depth image can contain 3-dimensional information about one or more objects. For example, a depth image described herein may contain a point cloud provided by a LIDAR sensor and/or a radar sensor. A depth image can, for example, be an image having depth information, provided by a LIDAR sensor.

The control device 106 can be configured to control the robot arm 120 on the basis of an output of the robot control model 112, in response to an input of at least one image into the robot control model 112.

The robot control model 112 can have a machine learning model. According to various aspects, the machine learning model can be generated (e.g., learned or trained) while the robot device 101 is not in operation. The generated machine learning model can then be used during the operation of the robot device 101 in order to ascertain skills to be carried out by the robot device 101. Optionally, the generated machine learning model can be additionally adapted (e.g., trained) during the operation of the robot device 101 (also referred to as online learning).

According to various aspects, the machine learning model can have or be a conditional neural network 306. The conditional neural network 306 described herein can be any type of conditional neural network, i.e., any type of neural network into which a condition (e.g., a context) can be input in addition to the input. For example, each layer of the conditional neural network 306 can be configured to apply as a function of the input condition a corresponding affine transformation to each feature ascertained in the layer. In clear terms, each layer can perform a feature-wise affine transformation of the features as a function of the condition.

For example, the conditional neural network 306 can have a FiLM architecture, as described in E. Perez: “FiLM: Visual Reasoning with a General Conditioning Layer”, arXiv:1709.07871, 2017. It is understood that this is an illustrative example and that the conditional neural network 306 can have any other architecture.

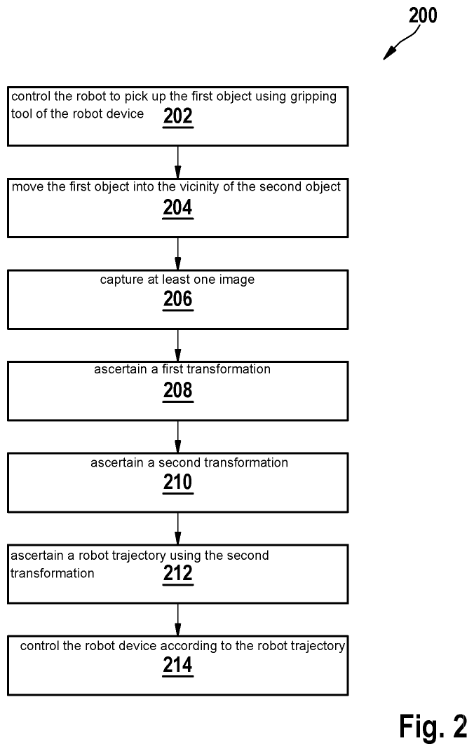

FIG. 2 is a flowchart of a (computer-implemented) method 200 for controlling a robot device to insert a first object into a second object according to various aspects.

The method 200 can (in 202) comprise controlling the robot device to pick up the first object (according to a pick-up robot configuration) by means of a gripping tool of the robot device.

The method 200 can (in 204) comprise moving the first object into the vicinity of the second object (according to an initial robot trajectory).

The method 200 can (in 206) comprise capturing at least one image showing the second object and the first object (picked up by means of the gripping tool and) located in the vicinity of the second object.

The method 200 can (in 208) comprise ascertaining, using the at least one image and/or at least one other image showing the first object and the gripping tool, a first transformation, which is a transformation between a coordinate system of the first object and a coordinate system of the gripping tool.

The method 200 can (in 210) comprise ascertaining a second transformation by inputting the at least one image as an input and the first transformation as a condition into a conditional neural network. The second transformation can (directly or indirectly) specify a transformation between the coordinate system of the gripping tool and a coordinate system of the second object.

The method 200 can (in 212) comprise ascertaining, using the second transformation, a robot trajectory for inserting the first object into the second object.

The method 200 can (in 214) comprise controlling the robot device according to the robot trajectory.

Various aspects of the method 200 are described in more detail below, with the first object being described as a plug 114 and the second object being described as a socket 116 for illustrative purposes.

According to various aspects, one or more images of the environment of the robot device 101 can be recorded (by means of the one or more imaging sensors 113). These one or more images can show the plug 114 and the socket. Using these one or more images, the control device 106 can recognize (e.g., locate) the plug 114 and the socket 116, ascertain a pick-up robot configuration for picking up (e.g., gripping) the plug 114 by means of the gripping tool 104, and ascertain an initial robot trajectory for moving the picked-up plug 114 into the vicinity of the socket 116 and control the robot arm 120 accordingly.

In some aspects, the steps 206 to 214 of the method 200 can always be carried out as soon as the picked-up plug 114 is in the vicinity of the socket 116. In other aspects, these steps 206 to 214 of the method 200 can be carried out only under predefined conditions. For example, as described in Reference [1], during the movement of the plug 114 (in 204), a current force and a current torque with which the gripping tool 104 has picked up (e.g., is holding, gripping, suctioning, etc.) the plug 114 can be (continuously) captured (e.g., measured) (e.g., by means of at least one force-torque sensor). The steps 206 to 214 of the method 200 can then be carried out if the current force is greater than or equal to a force threshold value and/or the current torque is greater than or equal to a torque threshold value. In clear terms, the force and the torque above the respective threshold values can indicate a collision between the plug 114 and the socket 116, and it can then be ascertained by means of the method 200 how the plug 114 can be inserted into the socket 116 without collision. Optionally, the force and/or the torque can be input as an input (in addition to the at least one image) into the conditional neural network 306.

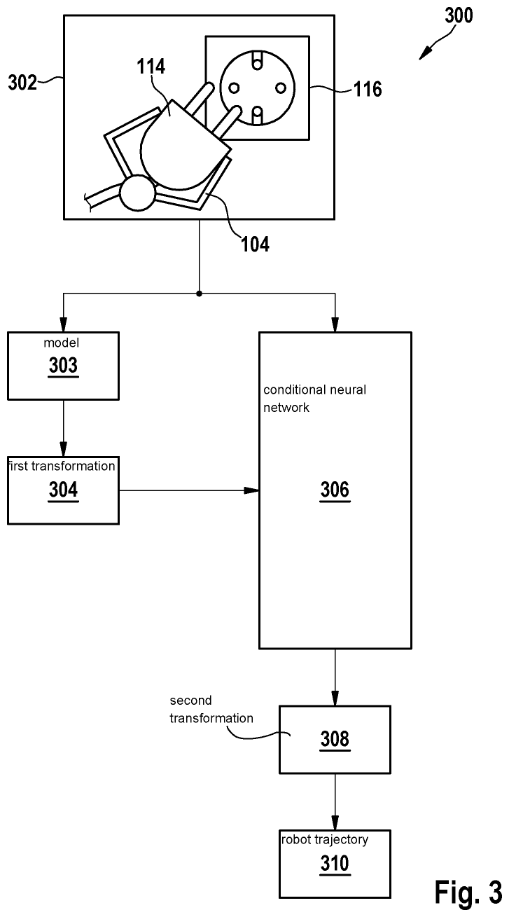

FIG. 3 is a schematic flowchart 300 for ascertaining the robot trajectory for inserting the plug 114 (as an exemplary first object) into the socket 116 (as an exemplary second object) according to various aspects.

In 206, the at least one image 302 showing the plug 114, picked up by the gripping tool 104, in the vicinity of the socket 116 can be captured. In some aspects, one image can be used for this purpose. In other aspects, multiple images (e.g., from different perspectives) can be used for this purpose.

In 208, the first transformation 304 between the coordinate system of the plug 114 and the coordinate system of the gripping tool 104 can then be ascertained. For this purpose, the at least one image 302 (as shown for illustration in FIG. 3), one or more images of a plurality of images, if the at least one image 302 is a plurality of images, or one or more completely different images can be used. In clear terms, one or more images showing at least the plug 114 and the gripping tool 104 by means of which the plug 114 is held can be used to ascertain the first transformation 304. These one or more images can, for example, be captured before and/or while the plug 114 is moved (in 204) into the vicinity of the socket 116. In clear terms, the first transformation 304 can specify how the plug 114 is gripped by the gripping tool 104.

The first transformation 304 can be ascertained using a model 303 that is configured to output the first transformation 304 in response to the input of the one or more images. For example, the model 303 can be a machine learning model. If the at least one image 302 is used to ascertain the first transformation 304, the machine learning model of the control model 112 can have, in addition to the conditional neural network 306, an (additional) prediction head, which is configured to predict the first transformation 304, which is then in turn input as a condition into the conditional neural network 306. Alternatively, the control model 112 can have an additional model (e.g., a machine learning model) that is configured to predict the first transformation 304 using the one or more images.

In 210, the at least one image 302 is input as an input and the first transformation 304 is input as a condition into the conditional neural network 306 in order to ascertain (e.g., predict) the second transformation 308. In clear terms, the second transformation 308 can be ascertained by taking into account the context of how the plug 114 is gripped by the gripping tool 104.

The second transformation 308 directly or indirectly specifies the transformation between the coordinate system of the gripping tool 104 and a coordinate system of the socket 116. For example, the second transformation 308 can be the transformation between the coordinate system of the plug 114 and the coordinate system of the socket 116, and the transformation between the coordinate system of the gripping tool 104 and the coordinate system of the socket 116 can then be ascertained using the first transformation 304. The transformation between the coordinate system of the gripping tool 104 and the coordinate system of the socket 116 can also be referred to as the insertion difference or insertion delta.

In 212, the robot trajectory 310 for inserting the plug 114 into the socket 116 can then be ascertained using the second transformation 308.

1-10. (canceled)

11. A method for controlling a robot device to insert a first object into a second object, the method comprising the following steps:
controlling the robot device to pick up the first object using a gripping tool of the robot device;
moving the first object into a vicinity of the second object;
capturing at least one image showing the second object and the first object located in the vicinity of the second object;
ascertaining, using the at least one image and/or at least one other image showing the first object and the gripping tool, a first transformation, which is a transformation between a coordinate system of the first object and a coordinate system of the gripping tool;
ascertaining a second transformation by inputting the at least one image as an input and the first transformation as a condition into a conditional neural network, wherein the second transformation specifies a transformation between the coordinate system of the gripping tool and a coordinate system of the second object;
ascertaining, using the second transformation, a robot trajectory for inserting the first object into the second object; and
controlling the robot device according to the robot trajectory.

12. The method according to claim 11, wherein the ascertaining of the first transformation using the at least one image and/or the at least one other image includes:
inputting the at least one image and/or the at least one other image into a machine learning model that is configured to output the first transformation in response to the input of the at least one image and/or the at least one other image.

13. The method according to claim 11, further comprising:
during the moving of the first object into the vicinity of the second object according to an initial robot trajectory:
capturing a current force and a current torque with which the gripping tool has picked up the first object, and
ascertaining whether the current force is greater than or equal to a force threshold value and whether the current torque is greater than or equal to a torque threshold value,
wherein the robot trajectory is ascertained by ascertaining the first transformation and the second transformation, and the robot device is controlled according to the robot trajectory when the current force is greater than or equal to the force threshold value and the current torque is greater than or equal to the torque threshold value.

14. The method according to claim 11, wherein the conditional neural network has a plurality of layers, each layer of the plurality of layers is configured to apply, as a function of the input condition, a corresponding affine transformation to each feature ascertained in the layer.

15. The method according to claim 11, wherein one of:
the second transformation is the transformation between the coordinate system of the gripping tool and the coordinate system of the second object; or
wherein the second transformation is a transformation between the coordinate system of the first object and the coordinate system of the second object, and specifies, using the first transformation, the transformation between the coordinate system of the gripping tool and the coordinate system of the second object.

16. The method according to claim 11, wherein the controlling of the robot device according to the robot trajectory includes:
controlling a robot arm of the robot device according to the robot trajectory, wherein the robot arm has the gripping tool.

17. A control device configured to control a robot device to insert a first object into a second object, the control device configured to perform the following steps:
controlling the robot device to pick up the first object using a gripping tool of the robot device;
moving the first object into a vicinity of the second object;
capturing at least one image showing the second object and the first object located in the vicinity of the second object;
ascertaining, using the at least one image and/or at least one other image showing the first object and the gripping tool, a first transformation, which is a transformation between a coordinate system of the first object and a coordinate system of the gripping tool;
ascertaining a second transformation by inputting the at least one image as an input and the first transformation as a condition into a conditional neural network, wherein the second transformation specifies a transformation between the coordinate system of the gripping tool and a coordinate system of the second object;
ascertaining, using the second transformation, a robot trajectory for inserting the first object into the second object; and
controlling the robot device according to the robot trajectory.

18. A robot device, comprising:
a robot arm with a gripping tool; and
a control device configured to control the robot device to insert a first object into a second object, the control device configured to perform the following steps:
controlling the robot device to pick up the first object using the gripping tool,
moving the first object into a vicinity of the second object,
capturing at least one image showing the second object and the first object located in the vicinity of the second object,
ascertaining, using the at least one image and/or at least one other image showing the first object and the gripping tool, a first transformation, which is a transformation between a coordinate system of the first object and a coordinate system of the gripping tool,
ascertaining a second transformation by inputting the at least one image as an input and the first transformation as a condition into a conditional neural network, wherein the second transformation specifies a transformation between the coordinate system of the gripping tool and a coordinate system of the second object,
ascertaining, using the second transformation, a robot trajectory for inserting the first object into the second object, and
controlling the robot device according to the robot trajectory.

19. A non-transitory computer-readable medium on which are stored commands to control a robot device to insert a first object into a second object, the commands, when executed by a processor, causing the processor to perform the following steps comprising:
controlling the robot device to pick up the first object using a gripping tool of the robot device;
moving the first object into a vicinity of the second object;
capturing at least one image showing the second object and the first object located in the vicinity of the second object;
ascertaining, using the at least one image and/or at least one other image showing the first object and the gripping tool, a first transformation, which is a transformation between a coordinate system of the first object and a coordinate system of the gripping tool;
ascertaining a second transformation by inputting the at least one image as an input and the first transformation as a condition into a conditional neural network, wherein the second transformation specifies a transformation between the coordinate system of the gripping tool and a coordinate system of the second object;
ascertaining, using the second transformation, a robot trajectory for inserting the first object into the second object; and
controlling the robot device according to the robot trajectory.
